(19) United States
(12) Patent Application Publication
(10) Pub. No.: US 2011/0005491 A1
(43) Pub. Date: Jan. 13, 2011

(54) FUEL INJECTION CONTROL APPARATUS OF INTERNAL COMBUSTION ENGINE

(75) Inventors: Yasuyuki Terada, Toyota-shi (JP); Mitsuhiro Nada, Toyota-shi (JP); Akio Matsunaga, Toyota-shi (JP); Makio Tsuchiyama, Toyota-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, JP (JP)

(21) Appl. No.: 12/812,585

(22) PCT Filed: Dec. 4, 2008
(86) PCT No.: PCT/JP2008/003595

§ 371 Date: Aug. 26, 2010

(30) Foreign Application Priority Data
Jan. 11, 2008 (JP) 2008-004198

(51) Int. Cl. F02B 3/00

(52) U.S. Cl. 123/299

(57) ABSTRACT

In one embodiment, a total pilot injection amount is calculated from the difference between a compressed gas temperature in a cylinder and a fuel self-ignition temperature. As pilot injection, a plurality of instances of divided pilot injection are performed, and by setting the injection amount per one instance of divided pilot injection to an injector minimum limit injection amount, each divided pilot injection amount is suppressed, and the penetration of fuel is suppressed to a low level so that attachment of fuel to a wall face is avoided, and also, fuel is caused to accumulate in the center portion of the cylinder.

This is a 371 national phase application of PCT/JP2008/003595 filed 4 Dec. 2008, which claims priority to Japanese Patent Application No. 2008-004198 filed 11 Jan. 2008, the contents of which are incorporated herein by reference.

### FIELD OF THE INVENTION

The present invention relates to a fuel injection control apparatus of an internal combustion engine represented by a diesel engine. More specifically, the present invention relates to, with respect to a compression self-igniting internal combustion engine in which it is possible to execute sub injection (also referred to below as pilot injection) prior to main injection from a fuel injection valve, improvement in the form of injection in this sub injection.

### BACKGROUND OF THE INVENTION

As is conventionally known, in a diesel engine used as an automobile engine or the like, fuel injection control is performed that adjusts a fuel injection timing and a fuel injection amount from a fuel injection valve (also referred to below as an injector) according to an operating state, such as the engine revolutions, amount of accelerator operation, coolant temperature, and intake air temperature.

Incidentally, diesel engine combustion is composed of premixed combustion and diffusive combustion. When fuel injection from a fuel injection valve begins, first a combustible mixture is produced by vaporization and diffusion of fuel (ignition delay period). Next, this combustible mixture self-ignites at about the same time at numerous places in a combustion chamber, and combustion rapidly progresses (premixed combustion). Further, fuel injection into the combustion chamber is continued, so that combustion is continuously performed (diffusive combustion). Afterward, unburned fuel exists even after fuel injection has ended, so heat continues to be generated for some period of time (afterburning period).

Also, in a diesel engine, as the ignition delay period grows longer, or as the vaporization of fuel during the ignition delay period grows more intense, a flame propagation speed after ignition will increase. When this flame propagation speed is large, the amount of fuel that burns at once becomes too great, pressure inside the cylinder drastically increases, and so vibration or noise occurs. Such a phenomenon is called diesel knocking, and often occurs particularly when operating with a low load. Also, in this sort of situation, a drastic elevation in burn temperature is accompanied by an increase in the amount of nitrogen oxide (referred to below as “NOx”) produced, and thus exhaust emissions become worse.

Consequently, in order to prevent such diesel knocking and reduce the amount of NOx produced, various fuel injection control apparatuses have been developed. For example, a fuel injection apparatus has been developed whereby pilot injection that injects a small amount of fuel is performed prior to main injection that causes combustion contributing to the production of engine torque. That is, the temperature within the cylinder is increased by preheating the fuel that has been injected with this pilot injection within the cylinder, and thus, the in-cylinder temperature (for example, a compression end temperature) at the injection timing of main injection is raised to the fuel self-ignition temperature, thus suppressing an ignition delay in main injection (see below Patent Citations 1 to 2).

Patent Citation 1 discloses, in a diesel engine provided with a common rail-type fuel injection apparatus, in a case where the absolute value of the difference between an actual common rail inner pressure and a target common rail inner pressure is at least a threshold value, performing pilot injection divided into two instances of injection. Patent Citation 2 discloses preventing injection amount pulsation due to the influence of pressure pulsation within a fuel high pressure pipe by performing pilot injection divided into three instances of injection.

### PTL 1: JP 2003-74403A

### PTL 2: JP 2004-27939A

### SUMMARY OF THE INVENTION

### Technical Problem

Incidentally, it is preferable that the fuel injected with the above main injection is atomized in order to have good ignitability and in order to shorten the ignition period. For this fuel atomization, it is necessary to set a high fuel injection pressure. For example, in the diesel engine provided with a common rail-type fuel injection apparatus disclosed in each of the above Patent Citations, the target value of the common rail inner pressure (the target value when running the engine under a high load, for example), which determines the fuel injection pressure, is set to a very high value of about 400 MPa, and thus fuel atomization is achieved.

On the other hand, when injecting fuel with the above pilot injection, at this injection timing, the piston is still positioned before the compression top dead center position, and pressure in the cylinder is low, so this is not a condition in which fuel combusts immediately after pilot injection. Therefore, the injected fuel is supplied into the cylinder in the spray state (supplied in the premixed state).

The inventors of the present invention, taking consideration of the state of fuel required at the time of the above main injection and the state of fuel that has been injected with pilot injection, examined the following points with regard to a technique for determining the form of injection when executing pilot injection, and investigated construction of that determination technique.

In a case where the common rail inner pressure is set to a high pressure, in order to achieve atomization of fuel in main injection as described above, a condition is established in which the fuel injected with pilot injection also is injected into the cylinder with a high injection pressure.

In such a condition, when the amount of pilot injection per instance is set comparatively large, the penetration of fuel that has been injected with this pilot injection is very high, so a large amount of the spray of that fuel will arrive at a wall face in the cylinder (cylinder inner wall face), and thus there is a high possibility that lubricant oil will be diluted by fuel that has reached the cylinder inner wall face, or that so-called bore flashing will occur in which lubricant oil of the cylinder inner wall face is washed away. Also, there is a possibility that, because of this fuel affixed to the cylinder inner wall face, HC and CO in the exhaust gas will increase, and thus exhaust emissions become worse.

On the other hand, fuel (spray) that has not arrived at the cylinder inner wall face arrives near the cylinder inner wall face due to the above high penetration, and is dispersed throughout a wide range within the cylinder. Therefore, the air-fuel ratio is substantially lean throughout the entire interior of the cylinder. As a result, there is a possibility that even if the compression stroke progresses, the fuel that has been injected with this pilot injection does not ignite, and so the effects due to performing pilot injection cannot be obtained.

In order to eliminate such problems, it is conceivable to set the common rail inner pressure to a low pressure and thus suppress the injection pressure in pilot injection to a low pressure, but here atomization of fuel injected with main injection is impaired so that ignition worsens, and thus there is a concern that smoke will be produced.

Also, it is conceivable to delay the injection timing of pilot injection, but here there is a risk that pilot injection will be performed at a timing when the cylinder inner pressure is increased, fuel combustion will start concurrently with the pilot injection, and thus the amount of oxygen consumption will increase locally, and in this case also there is a concern that smoke will be produced.

Furthermore, even in a condition in which fuel that has been injected with pilot injection has high penetration and thus is dispersed throughout a wide range within the cylinder, in order to establish a rich state for the air-fuel ratio such that ignition is possible when the compression stroke has advanced, it is conceivable to increase the amount of fuel injection in pilot injection. However, in this case, the amount of heat absorbed by an endothermic reaction of fuel that has been injected with pilot injection greatly increases, and there is a high possibility that an ignition delay will occur for pilot injection, and as a result it is not possible to adequately obtain the effects of pilot injection (an effect of suppressing an ignition delay in main injection by increasing the in-cylinder temperature). In addition, the amount of fuel consumption increases, leading to worsened engine fuel efficiency. Further, because of the ignition delay in pilot injection, there is a possibility that combustion noise will increase, and that torque (reverse torque) will be produced before the piston arrives at the compression top dead center. In other words, with conventional pilot injection, in order to adequately obtain the effects of pilot injection, there is a limit to the total pilot injection amount injected with pilot injection. Therefore, the present state of affairs is such that even in a case where a large amount of pre-heating is required in pilot injection, particularly such as when the engine is cold, because the total pilot injection amount is restricted, the inside of the cylinder cannot be adequately pre-heated, resulting in an ignition delay in main injection despite performing pilot injection.

In order to avoid an ignition delay in main injection when the engine is cold, for example, the engine may be designed to have a high compression ratio, but in this case, there is a decrease in efficiency due to friction, and a possibility that combustion temperature will be high when the engine is warm and thus an increase in the amount of NOx that is discharged, so this is not suitable for practical use.

Up to now, there have not been any proposals for a technique for determining the form of injection in pilot injection that take into consideration the various points as described above. The inventors of the present invention arrived at the invention by investigating construction of a new determination technique for determining the form of injection in pilot injection, in consideration of the above points.

The present invention addresses the above problems by, with respect to an internal combustion engine made capable of executing pilot injection prior to main injection, performing fuel injection using a technique for determining a form of injection whereby it is possible to achieve optimization of the form of injection in pilot injection.

### Solution to Problem

Principles of Solution

As for the solving principles of the present invention, when executing sub injection, the total sub injection amount required in this sub injection is divided into a plurality of instances of divided sub injection, and by suppressing penetration of fuel injected with the individual instances of divided sub injection to a low level, this fuel is locally accumulated without being allowed to attach to a wall face, and thus the above problems are eliminated.

Solving Means

The present invention provides a fuel injection control apparatus of a compression self-igniting internal combustion engine that, as an operation to inject fuel from a fuel injection valve, is capable of executing at least a main injection and a sub injection that is performed prior to the main injection, the fuel injection control apparatus comprising: a total sub injection amount calculation portion that obtains a total sub injection amount required in the sub injection; and a sub injection control portion that intermittently injects from the fuel injection valve the total sub injection amount that has been obtained with the total sub injection amount calculation portion by dividing the total sub injection amount by a plurality of instances of divided sub injection; in which a fuel injection amount or an open valve period of the fuel injection valve per one instance of the divided sub injection is set as a value whereby penetration of fuel injected from the fuel injection valve is limited to a size such that fuel does not reach a cylinder inner wall face, and the sub injection control portion is configured to set the injection timing of each instance of divided sub injection such that fuel is injected at a timing that the fuel does not overlap with fuel that is injected with each instance of divided sub injection and flows along a swirl flow within the cylinder.

In other words, the fuel injection amount or the open valve period of the fuel injection valve per one instance of the divided sub injection is limited such that fuel injected with the divided sub injection has a penetration of a size such that the flight distance of that fuel does not reach the cylinder inner wall face. In this case, when the fuel pressure is comparatively high, it is not possible to limit the flight distance unless the fuel injection amount or the open valve period of the fuel injection valve per one instance of the divided sub injection is restricted, but when the fuel pressure is comparatively low, if the flight distance is suppressed to within a limited distance (for example, within a cavity (concave portion) formed in the top face of the piston), it is possible to mitigate the restriction of the fuel injection amount or the open valve period of the fuel injection valve per one instance of the divided sub injection. Also, fuel injected with divided sub injection performed a plurality of times does not overlap (is not superimposed), and for example, is uniformly (at intervals of the same angle) injected in the center portion within the cylinder.

With the above specific configuration, fuel injected into the cylinder with the instances of divided sub injection has a low penetration, so almost none of this fuel reaches the cylinder inner wall face. That is, it is possible to suppress wall attachment of fuel, and thus, it is possible to prevent the dilution of lubricant oil or the occurrence of the above-described bore flashing due to fuel. Also, it is possible to greatly reduce the amount of HC and CO produced in exhaust gas that has been produced due to fuel affixed to the cylinder inner wall face, so improvement of exhaust emissions is achieved. Further, even while avoiding a condition in which the amount of oxygen consumption increases locally and there is a concern that smoke will be produced, a region of a comparatively rich air-fuel ratio is insured, and ignition delay of sub injection is avoided. Therefore, it is possible to reliably obtain the effects of sub injection, namely, increasing the in-cylinder temperature. Also, it is possible to avoid an increase in combustion noise caused by an ignition delay in sub injection, and possible to avoid production of torque (reverse torque) before the piston reaches the compression top dead center.

Also, it is possible to cause most of the fuel of the total pilot injection amount to exist (float) locally within the cylinder (for example, in the center portion within the cylinder), and in that portion it is possible to insure a rich state of the air-fuel ratio. Therefore, when the compression stroke has advanced, it is possible to favorably perform ignition of fuel that has been injected with sub injection, effects due to executing sub injection (an effect of increasing the in-cylinder temperature) can be favorably obtained, and it is possible to appropriately obtain the ignition timing in main injection. For example, when the target ignition timing in main injection has been set to the compression top dead center (TDC) of the piston, it is possible to make the ignition timing of fuel that has been injected with main injection match this target ignition timing.

In addition, the fuel injection amount per one instance of divided sub fuel injection is set to a small amount in order to obtain a low penetration, and the amount of fuel absorbed by the endothermic reaction of fuel during this divided sub fuel injection is slight. Accordingly, without an ignition delay occurring in sub injection, it is possible to adequately insure the effects of sub injection, namely, raising the in-cylinder temperature. Also, it is possible to avoid an increase in combustion noise caused by an ignition delay in sub injection, and possible to avoid production of torque (reverse torque) before the piston reaches the compression top dead center.

For the above reasons, while the total sub injection amount is limited in the conventional technology, with the present solving means, it is possible to eliminate that limitation, and so a total sub injection amount with an amount corresponding to the operational state of the internal combustion engine can be supplied into the cylinder. For example, in a case where a large amount of temperature increase of the in-cylinder temperature is required (a case where a large total pilot injection amount is required), such as when the internal combustion engine is cold, it is possible to insure a comparatively large total pilot injection amount that corresponds to that condition, and it is possible to adequately pre-heat the inside of the cylinder by effectively using most of fuel that has been injected with sub injection.

As the fuel injection amount of divided sub injection that is set by the sub injection control portion, the fuel injection amount per one instance of the divided sub injection may be set to a minimum limit injection amount of the fuel injection valve.

Also, as the open valve period of the fuel injection valve that is set by the sub injection control portion, the open valve period per one instance of the divided sub injection may be set to a shortest open valve period of the fuel injection valve.

According to these configurations, it is possible to suppress the absorption amount by the endothermic reaction of fuel during the divided sub injection to the minimum limit, so an ignition delay does not occur in sub injection. Therefore, it is possible to reliably obtain the effects of sub injection, namely, increasing the in-cylinder temperature.

A configuration may be adopted in which, as the total sub injection amount obtained with the total sub injection amount calculation portion, specifically when the fuel injected with the sub injection, due to combustion of that fuel, is used as a heat source for raising the compressed gas temperature within the cylinder to the fuel self-ignition temperature during the compression stroke of the internal combustion engine, a greater total sub injection amount is set as the compressed gas temperature within the cylinder becomes further below the fuel self-ignition temperature.

That is, a greater total sub injection amount is set for cases in which a greater temperature increase amount of the compressed gas temperature is required, so that it is possible to increase the amount of the heat energy obtained with fuel combustion. In this case as well, the fuel injected into the cylinder in each instance of divided fuel injection has a low penetration. Therefore, as a greater total sub injection amount is set, the number of divisions (number of instances of divided sub injection) for the total sub injection amount increases.

Following is an example of a configuration for causing the fuel injected with the above divided sub injection executed a plurality of times to be uniformly accumulated in a specific region (for example, the center portion within the cylinder). That is, the fuel injection valve injects fuel from a plurality of injection port; and the sub injection control portion, in a state that fuel of divided sub injection that has been injected from the injection port on the upstream side in the swirl flow direction is flowing towards a position opposing the injection port on the downstream side in the swirl flow direction, sets the injection timing of each instance of divided sub injection such that a subsequent instance of divided sub injection is executed before the fuel of the previously-executed instance of divided sub injection arrives at the position opposing the injection port on the downstream side in the swirl flow direction.

In this case, the specific injection timing of the divided sub injection can be prescribed from a value obtained by converting an injection interval between relatively preceding and subsequent instances of divided sub injection (divided sub injection interval) to a crank rotation angle (CA), and is set in the following manner. That is,

for a number of injection instances of divided sub injection calculated with below formula (1),

(number of instances of divided sub injection)=(total sub injection amount required in sub injection)/(minimum limit injection amount of fuel injection valve) (1)

the divided sub injection is executed at each of a crank rotation angle conversion value of an interval between instances of divided sub injection calculated with below formula (2).

(crank rotation angle conversion value of interval between instances of divided sub injection)=360/(number of injection ports of fuel injection valve)/(number of instances of divided sub injection)/(swirl ratio) (2)

For example, when the number of instances of divided fuel injection is set to “three instances” according to formula (1), the number of injection ports of the fuel injection valve is “10”, and the swirl ratio (number of times that the swirl flow goes around in the circumferential direction within the cylinder per one revolution of the crank shaft) is “2”, 6 degrees CA is obtained as the crank rotation angle conversion value of the interval between instances of divided sub injection. That is, by intermittently executing divided sub injection each time that the crank shaft rotation angle advances 6 degrees CA, fuel that has been injected with each instance of divided sub injection (fuel that has been injected three times from each injection port) does not overlap, and is injected uniformly in the center portion within the cylinder.

### ADVANTAGEOUS EFFECTS

With the present invention, with respect to a compression self-igniting internal combustion engine, when executing sub injection prior to main injection, by dividing the total sub injection amount required in this sub injection into a plurality of instances of divided sub injection, and suppressing penetration of fuel injected with the individual instances of divided sub injection to a low level, this fuel is locally accumulated without being allowed to attach to a wall face. Thus, it is possible to execute sub injection using a new determination technique for determining the form of injection in sub injection, so it is possible to achieve an improvement in exhaust emissions and stabilization of combustion during main injection.

### BRIEF DESCRIPTION OF DRAWINGS

FIG. 1 is a schematic configuration diagram of an engine and a control system of that engine according to an embodiment.

FIG. 2 is a cross-sectional view that shows a combustion chamber of a diesel engine and parts in the vicinity of that combustion chamber.

FIG. 3 is a block diagram that shows the configuration of a control system of an ECU or the like.

FIGS. 4(a) to 4(c) show an injection pattern, heat production ratio, and fuel injection pressure for each of pilot injection, pre-injection, and main injection in a case where pilot injection is divided into three instances.

FIG. 5 is a cross-sectional view that shows a combustion chamber of a diesel engine and parts in the vicinity of that combustion chamber when executing divided pilot injection.

FIGS. 6(a) to 6(c) are plan views that show the spray state in a cylinder in a case where each of a first, second, and third divided pilot injection are performed, with FIG. 6(a) showing the spray state in the cylinder when executing the first divided pilot injection, FIG. 6(b) showing the spray state in the cylinder when executing the second divided pilot injection, and FIG. 6(c) showing the spray state in the cylinder when executing the third divided pilot injection.

### EXPLANATION OF REFERENCE

1 Engine (internal combustion engine)
12 Cylinder bore
23 Injector (fuel injection valve)

### DETAILED DESCRIPTION

Following is a description of an embodiment of the invention based on the drawings. In the present embodiment, a case will be described in which the invention is applied to a common rail in-cylinder direct injection multi-cylinder (for example, inline four-cylinder) diesel engine (compression self-igniting internal combustion engine) mounted in an automobile.

Engine Configuration

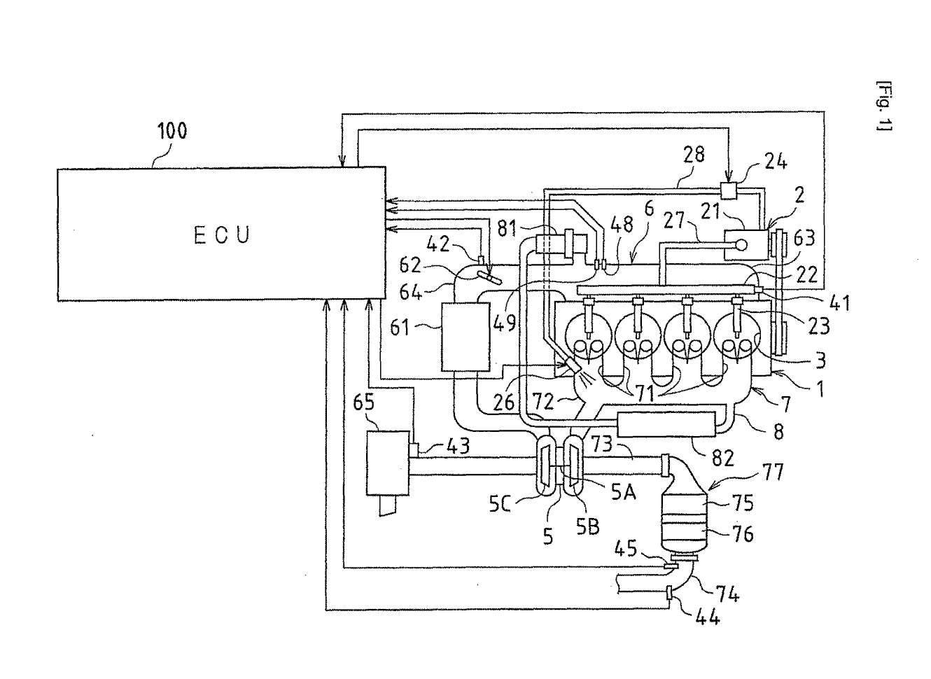

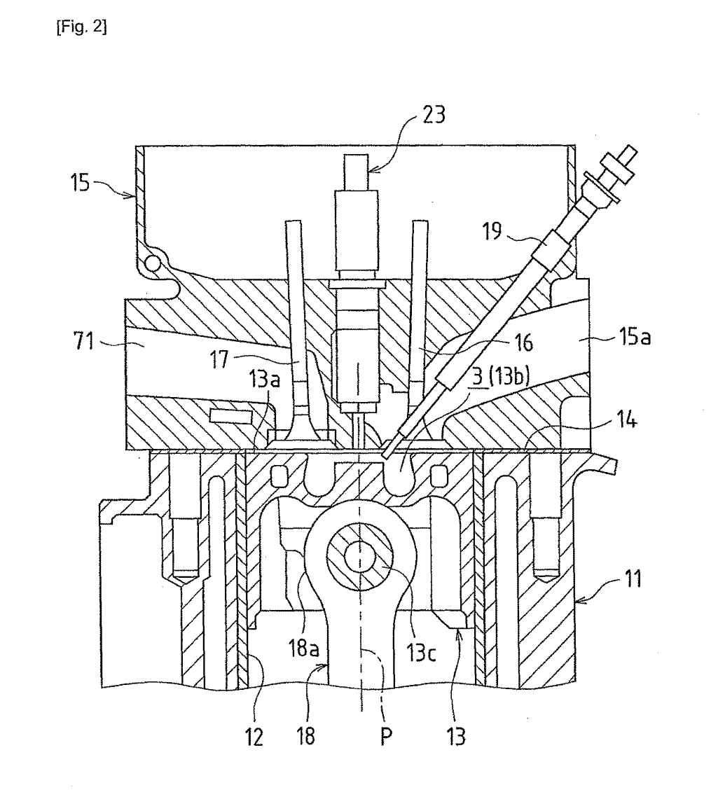

First, the overall configuration of a diesel engine (referred to below as simply the engine) according to the present embodiment will be described. FIG. 1 is a schematic configuration diagram of the engine 1 and a control system of the engine 1 according to this embodiment. FIG. 2 is a cross-sectional view that shows a combustion chamber 3 of the diesel engine and parts in the vicinity of the combustion chamber 3.

As shown in FIG. 1, the engine 1 according to this embodiment is a diesel engine system configured using a fuel supply system 2, combustion chambers 3, an intake system 6, an exhaust system 7, and the like as its main portions.

The fuel supply system 2 is provided with a supply pump 21, a common rail 22, injectors (fuel injection valves) 23, a cutoff valve 24, a fuel addition valve 26, an engine fuel path 27, an added fuel path 28, and the like.

The supply pump 21 draws fuel from a fuel tank, and after putting the drawn fuel under high pressure, supplies that fuel to the common rail 22 via the engine fuel path 27. The common rail 22 has a function as an accumulation chamber where high pressure fuel supplied from the supply pump 21 is held (accumulated) at a predetermined pressure, and this accumulated fuel is distributed to each injector 23. The injectors 23 are configured from piezo injectors within which a piezoelectric element (piezo element) is provided, and supply fuel by injection into the combustion chambers 3 by appropriately opening a valve. The details of control of fuel injection from the injectors 23 will be described later.

Also, the supply pump 21 supplies part of the fuel drawn from the fuel tank to the fuel addition valve 26 via the added fuel path 28. In the added fuel path 28, the aforementioned cutoff valve 24 is provided in order to stop fuel addition by cutting off the added fuel path 28 during an emergency.

The fuel addition valve 26 is configured from an electronically controlled opening/closing valve whose valve opening timing is controlled with an addition control operation by an ECU 100 described later such that the amount of fuel added to the exhaust system 7 becomes a target addition amount (an addition amount such that exhaust A/F becomes target A/F), or such that a fuel addition timing becomes a predetermined timing. That is, a desired amount of fuel from the fuel addition valve 26 is supplied by injection to the exhaust system 7 (to an exhaust manifold 72 from exhaust ports 71) at an appropriate timing.

The intake system 6 is provided with an intake manifold 63 connected to an intake port 15a formed in a cylinder head 15 (see FIG. 2), and an intake tube 64 that comprises an intake path is connected to the intake manifold 63. Also, in this intake path, an air cleaner 65, an airflow meter 43, and a throttle valve 62 are disposed in order from the upstream side. The airflow meter 43 outputs an electrical signal according to the amount of air that flows into the intake path via the air cleaner 65.

The exhaust system 7 is provided with the exhaust manifold 72 connected to the exhaust ports 71 formed in the cylinder head 15 (see FIG. 2), and exhaust tubes 73 and 74 that comprise an exhaust path are connected to the exhaust manifold 72. Also, in this exhaust path, a maniverter (exhaust purification apparatus) 77 is disposed that is provided with a NOx storage catalyst (NSR catalyst: NOx Storage Reduction catalyst) 75 and a DPNR catalyst (Diesel Particulate-NOx Reduction catalyst) 76, described later. Following is a description of the NSR catalyst 75 and the DPNR catalyst 76.

The NSR catalyst 75 is a storage reduction NOx catalyst, and is configured using alumina (Al₂O₃) as a support, with, for example, an alkali metal such as potassium (K), sodium (Na), lithium (Li), or cesium (Cs), an alkaline earth element such as barium (Ba) or calcium (Ca), a rare earth element such as lanthanum (La) or Yttrium (Y), and a precious metal such as platinum (Pt) supported on this support.

The NSR catalyst 75, in a state in which a large amount of oxygen is present in the exhaust, stores NOx, and in a state in which the oxygen concentration in the exhaust is low and a large amount of a reduction component (for example, an unburned component (HC) of fuel) is present, reduces NOx to NO₂ or NO and releases the resulting NO₂ or NO. NOx that has been released as NO₂ or NO is further reduced due to quickly reacting with HC or CO in the exhaust and becomes N₂. Also, by reducing NO₂ or NO, HC and CO themselves are oxidized and thus become H₂0 and CO₂. In other words, by appropriately adjusting the oxygen concentration or the HC component in the exhaust introduced to the NSR catalyst 75, it is possible to purify HC, CO, and NOx in the exhaust. In the configuration of the present embodiment, adjustment of the oxygen concentration or the HC component in the exhaust can be performed with an operation to add fuel from the aforementioned fuel addition valve 26.

On the other hand, in the DPNR catalyst 76, a NOx storage reduction catalyst is supported on a porous ceramic structure, for example, and PM in exhaust gas is captured when passing through a porous wall. When the air-fuel ratio of the exhaust gas is lean, NOx in the exhaust gas is stored in the NOx storage reduction catalyst, and when the air-fuel ratio is rich, the stored NOx is reduced and released. Furthermore, a catalyst that oxidizes/burns the captured PM (for example, an oxidization catalyst whose main component is a precious metal such as platinum) is supported on the DPNR catalyst 76.

Here, the combustion chamber 3 of the diesel engine and parts in the vicinity of the combustion chamber 3 will be described with reference to FIG. 2. As shown in FIG. 2, in a cylinder block 11 that constitutes part of the main body of the engine, a cylindrical cylinder bore 12 is formed in each cylinder (each of four cylinders), and a piston 13 is housed within each cylinder bore 12 such that the piston 13 can slide in the vertical direction.

The aforementioned combustion chamber 3 is formed on the top side of a top face 13a of the piston 13. More specifically, the combustion chamber 3 is partitioned by a lower face of the cylinder head 15 installed on top of the cylinder block 11 via a gasket 14, an inner wall face of the cylinder bore 12, and the top face 13a of the piston 13. A cavity 13b is concavely provided in approximately the center of the top face 13a of the piston 13, and this cavity 13b also constitutes part of the combustion chamber 3.

A small end 18a of a connecting rod 18 is linked to the piston 13 by a piston pin 13c, and a large end of the connecting rod 18 is linked to a crank shaft that is an engine output shaft. Thus, back and forth movement of the piston 13 within the cylinder bore 12 is transmitted to the crank shaft via the connecting rod 18, and engine output is obtained due to rotation of this crank shaft. Also, a glow plug 19 is disposed facing the combustion chamber 3. The glow plug 19 glows due to the flow of electrical current immediately before the engine 1 is started, and functions as a starting assistance apparatus whereby ignition and combustion are promoted due to part of a fuel spray being blown onto the glow plug.

In the cylinder head 15, the intake port 15a that introduces air to the combustion chamber 3 and the exhaust port 71 that discharges exhaust gas from the combustion chamber 3 are respectively formed, and an intake valve 16 that opens/closes the intake port 15a and an exhaust valve 17 that opens/closes the exhaust port 71 are disposed. The intake valve 16 and the exhaust valve 17 are disposed facing each other on either side of a cylinder center line P. That is, this engine is configured as a cross flow-type engine. Also, the injector 23 that injects fuel directly into the combustion chamber 3 is installed in the cylinder head 15. The injector 23 is disposed in approximately the center above the combustion chamber 3, in an erect orientation along the cylinder center line P, and injects fuel introduced from the common rail 22 toward the combustion chamber 3 at a predetermined timing.

Furthermore, as shown in FIG. 1, a turbocharger 5 is provided in the engine 1. This turbocharger 5 is provided with a turbine wheel 5B and a compressor wheel 5C that are linked via a turbine shaft 5A. The compressor wheel 5C is disposed facing the inside of the intake tube 64, and the turbine wheel 5B is disposed facing the inside of the exhaust tube 73. Thus the turbocharger 5 uses exhaust flow (exhaust pressure) received by the turbine wheel 5B to rotate the compressor wheel 5C, thereby performing a so-called turbocharging operation that increases the intake pressure. In this embodiment, the turbocharger 5 is a variable nozzle-type turbocharger, in which a variable nozzle vane mechanism (not shown) is provided on the turbine wheel 5B side, and by adjusting the opening degree of this variable nozzle vane it is possible to adjust the turbocharging pressure of the engine 1.

An intercooler 61 for forcibly cooling intake air heated due to supercharging with the turbocharger 5 is provided in the intake tube 64 of the intake system 6. The throttle valve 62 provided on the downstream side from the intercooler 61 is an electronically controlled opening/closing valve whose opening degree is capable of stepless adjustment, and has a function to constrict the area of the channel of intake air under predetermined conditions, and thus adjust (reduce) the supplied amount of intake air.

Also, an exhaust gas recirculation path (EGR path) 8 is provided that connects the intake system 6 and the exhaust system 7. The EGR path 8 decreases the combustion temperature by appropriately recirculating part of the exhaust to the intake system 6 and resupplying that exhaust to the combustion chamber 3, thus reducing the amount of NOx produced. Also, provided in the EGR path 8 are an EGR valve 81 that by being opened/closed continuously under electronic control is capable of freely adjusting the amount of exhaust flow that flows through the EGR path 8, and an EGR cooler 82 for cooling exhaust that passes through (recirculates through) the EGR path 8.

Sensors

Various sensors are installed in respective parts of the engine 1, and these sensors output signals related to environmental conditions of the respective parts and the operating state of the engine 1.

For example, the above airflow meter 43 outputs a detection signal according to an intake air flow amount (intake air amount) on the upstream side of the throttle valve 62 within the intake system 6. An intake temperature sensor 49 is disposed in the intake manifold 63, and outputs a detection signal according to the temperature of intake air. An intake pressure sensor 48 is disposed in the intake manifold 63, and outputs a detection signal according to the intake air pressure. An A/F (air-fuel ratio) sensor 44 outputs a detection signal that continuously changes according to the oxygen concentration in exhaust on the downstream side of the maniverter 77 of the exhaust system 7. An exhaust temperature sensor 45 likewise outputs a detection signal according to the temperature of exhaust gas (exhaust temperature) on the downstream side of the maniverter 77 of the exhaust system 7. A rail pressure sensor 41 outputs a detection signal according to the pressure of fuel accumulated in the common rail 22. A throttle opening degree sensor 42 detects the opening degree of the throttle valve 62.

ECU

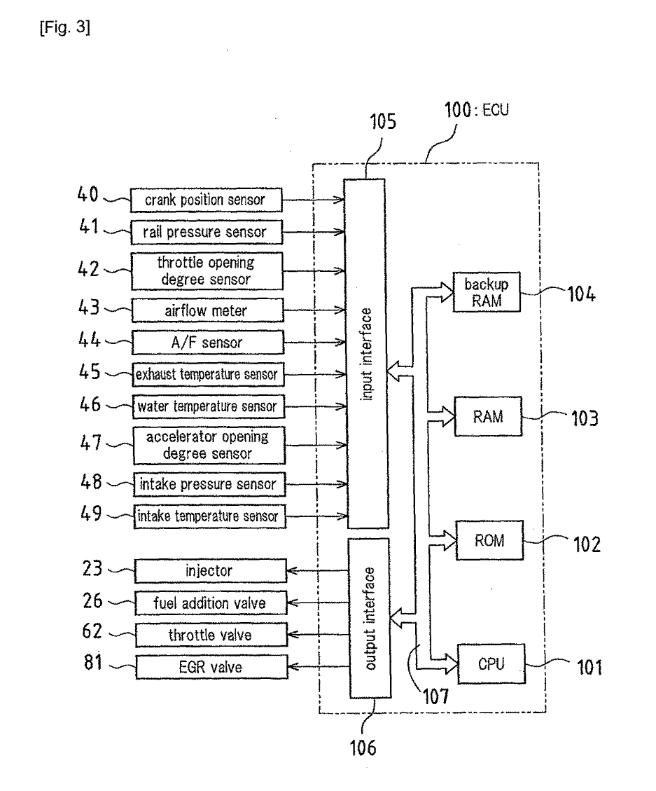

As shown in FIG. 3, the ECU 100 is provided with a CPU 101, a ROM 102, a RAM 103, a backup RAM 104, and the like. In the ROM 102, various control programs, maps that are referred to when executing those various control programs, and the like are stored. The CPU 101 executes various computational processes based on the various control programs and maps stored in the ROM 102. The RAM 103 is a memory that temporarily stores data resulting from computation with the CPU 101 or data that has been input from the respective sensors, and the backup RAM 104, for example, is a nonvolatile memory that stores that data or the like to be saved when the engine 1 is stopped.

The CPU 101, the ROM 102, the RAM 103, and the backup RAM 104 are connected to each other via a bus 107, and are connected to an input interface 105 and an output interface 106 via the bus 107.

The rail pressure sensor 41, the throttle opening degree sensor 42, the airflow meter 43, the A/F sensor 44, the exhaust temperature sensor 45, the intake pressure sensor 48, and the intake temperature sensor 49 are connected to the input interface 105. Further, a water temperature sensor 46, an accelerator opening degree sensor 47, a crank position sensor 40, and the like are connected to the input interface 105. The water temperature sensor 46 outputs a detection signal according to the coolant water temperature of the engine 1, the accelerator opening degree sensor 47 outputs a detection signal according to the amount that an accelerator pedal is depressed, and the crank position sensor 40 outputs a detection signal (pulse) each time that an output shaft (crank shaft) of the engine 1 rotates a fixed angle. On the other hand, the aforementioned injectors 23, fuel addition valve 26, throttle valve 62, EGR valve 81, and the like are connected to the output interface 106.

The ECU 100 executes various control of the engine 1 based on the output of the various sensors described above. Furthermore, the ECU 100 executes pilot injection control, described below, as control of fuel injection of the injectors 23.

The fuel injection pressure when the above injectors 23 execute fuel injection is determined from the inner pressure of the common rail 22. As the common rail internal pressure, ordinarily, the target value of the fuel pressure supplied from the common rail 22 to the injectors 23, i.e., the target rail pressure, is set to increase as the engine load increases, and as the number of engine revolutions increases. That is, when the engine load is high, a large amount of air is sucked into the combustion chamber 3, so pressure in the combustion chamber 3 is high and the injectors 23 are required to inject a large amount fuel, and therefore it is necessary to set a high injection pressure from the injectors 23. Also, when the number of engine revolutions is high, the injection time is short, so it is necessary to inject a large amount of fuel per unit time, and therefore it is necessary to set a high injection pressure from the injectors 23. In this way, the target rail pressure is ordinarily set based on the engine load and the number of engine revolutions.

The optimum values of fuel injection parameters for fuel injection in main injection and the like, described below, differ according to temperature conditions of the engine, intake air, and the like.

For example, the ECU 100 adjusts the amount of fuel discharged by the supply pump 21 such that the common rail pressure becomes the same as the target rail pressure set based on the engine operating state, i.e., such that the fuel injection pressure matches the target injection pressure. Also, the ECU 100 determines the fuel injection amount and the form of fuel injection based on the engine operating state. Specifically, the ECU 100 calculates an engine rotational speed based on the value detected by the crank position sensor 40, obtains an amount of accelerator pedal depression (accelerator opening degree) based on the value detected by the accelerator opening degree sensor 47, and determines the fuel injection amount based on the engine rotational speed and the accelerator opening degree.

Furthermore, the ECU 100 sets the form of fuel injection to various injection modes in which pilot injection, pre-injection, main injection, after injection, and post injection are appropriately combined, based on the engine rotational speed and the fuel injection amount. Following is a general description of the operation of the pilot injection, pre-injection, main injection, after injection, and post injection in the present embodiment.

This pilot injection (sub injection) is an injection operation that pre-injects a small amount of fuel prior to main injection from the injectors 23. More specifically, after execution of this pilot injection, fuel injection is temporarily interrupted, the temperature of compressed gas (temperature in the cylinder) is adequately increased to reach the fuel self-ignition temperature before main injection is started, and thus ignition of fuel injected by main injection is well-insured. That is, the function of pilot injection in the present embodiment is specialized for preheating the inside of the cylinder.

In the present embodiment, the total pilot injection amount, which is the fuel injection amount that is required in this pilot injection, is divided using a plurality of instances of pilot injection (referred to below as divided pilot injection), and thus intermittently injected from the injectors 23. A specific technique of setting this total pilot injection amount, and the fuel injection amount and injection timing for each instance of divided pilot injection, is described below.

(Pre-Injection)

Pre-injection is an injection operation for suppressing the initial combustion speed from main injection, thus leading to stable diffusive combustion (torque-producing fuel supply operation). Specifically, in this embodiment, a pre-injection amount is set that is 10% of the total injection amount (sum of injection amount in pre-injection and injection amount in main injection) for obtaining the required torque determined according to the operating state, such as the engine revolutions, amount of accelerator operation, coolant temperature, and intake air temperature.

In this case, when the above total injection amount is less than 15 mm³, the injection amount in pre-injection is less than the minimum limit injection amount (1.5 mm³) of the injectors 23, so pre-injection is not executed. In this case, pre-injection of only the minimum limit injection amount (1.5 mm³) of the injectors 23 may be performed. On the other hand, when a total injection amount in pre-injection that is at least twice (for example, at least 3 mm³) the minimum limit injection amount of the injectors 23 is required, the necessary total injection amount in this pre-injection is insured by executing a plurality of instances of pre-injection. Thus, the ignition delay of pre-injection is suppressed, suppression of the initial combustion speed from main injection is reliably performed, and so it is possible to lead to stable diffusion combustion.

The ignition start angle for this pre-injection is set according to below formula (3). Also note that the angle referred to below means a value converted to the rotation angle of the crank shaft.

Pre-injection start angle=pre-combustion end angle+pre-injection period working angle+(crank angle conversion value of combustion required time in pre-injection+crank angle conversion value of ignition delay time−crank angle conversion value of overlap time) (3)

Here, the ignition delay time is a delay time from the time that pre-injection is executed to the time when that fuel ignites. The overlap time is, when pre-injection is performed a plurality of times, an overlap time of the combustion time of fuel from previously executed pre-injection and combustion time of fuel from subsequently executed pre-injection (time during which two combustions are simultaneously being performed), and an overlap time of the combustion time of fuel from final pre-injection and the combustion time of fuel from subsequently executed main injection, and also an overlap time of the combustion time of fuel from final pilot injection and the combustion time of fuel from pre-injection.

(Main Injection)

Main injection is an injection operation for producing torque of the engine 1 (torque-producing fuel supply operation). Specifically, in this embodiment, an injection amount is set that is obtained by subtracting the injection amount in the above pre-injection from the above total injection amount for obtaining the required torque determined according to the operating state, such as the engine revolutions, amount of accelerator operation, coolant temperature, and intake air temperature.

Also, the injection start angle for this main injection is set according to below formula (4).

Main injection start angle=main injection timing+main injection period working angle+(crank angle conversion value of combustion required time in main injection+crank angle conversion value of ignition delay time−crank angle conversion value of overlap time) (4)

Here, the ignition delay time is a delay time from the time that main injection is executed to the time when that fuel ignites. The overlap time is an overlap time of the combustion time of fuel from the above pre-injection and the combustion time of fuel from main injection, and an overlap time of the combustion time of fuel from main injection and the combustion time of fuel from after-injection.

(After-Injection)

After-injection is an injection operation for increasing the exhaust gas temperature. Specifically, in this embodiment, the combustion energy of fuel supplied by after-injection is not converted to engine torque, rather, after-injection is executed at a timing such that the majority of that combustion energy is obtained as exhaust heat energy. Also, in this after-injection as well, same as in the case of the pilot injection described above, the minimum injection ratio is set (for example, an injection amount of 1.5 mm³ per instance), and by executing after-injection a plurality of times, the total after-injection amount necessary in this after-injection is insured.

(Post-Injection)

Post-injection is an injection operation for achieving increased temperature of the above maniverter 77 by directly introducing fuel to the exhaust system 7. For example, when the deposited amount of PM captured by the DPNR catalyst 76 has exceeded a predetermined amount (for example, known from detection of a before/after pressure difference of the maniverter 77), post injection is executed.

Pilot Injection Control Operation

Next is a specific description of a control operation for executing the above pilot injection, which is an operation that is a feature of the present embodiment.

(Injection Ratio)

In this embodiment, in order to achieve an appropriate spray distribution and local concentration, an injection ratio is set to a minimum injection ratio (for example, an injection amount of 1.5 mm³ per instance), and by executing divided pilot injection a plurality of times, a total pilot injection amount necessary in this pilot injection is insured.

For example, when the total pilot injection amount is 3 mm³, divided pilot injection of 1.5 mm³, which is the minimum limit injection amount of the injector 23, is performed twice. When the total pilot injection amount is 4.5 mm³, divided pilot injection of 1.5 mm³, which is the minimum limit injection amount of the injector 23, is performed three times. Further, when the total pilot injection amount is 5 mm³, divided pilot injection of 1.5 mm³, which is the minimum limit injection amount of the injector 23, is performed twice, and then injection of 2.0 mm³ is performed once. When the total pilot injection amount is 2.0 mm³, divided pilot injection of 1.5 mm³, which is the minimum limit injection amount of the injector 23, is performed twice, thus insuring that the pilot injection amount is at least the necessary injection amount.

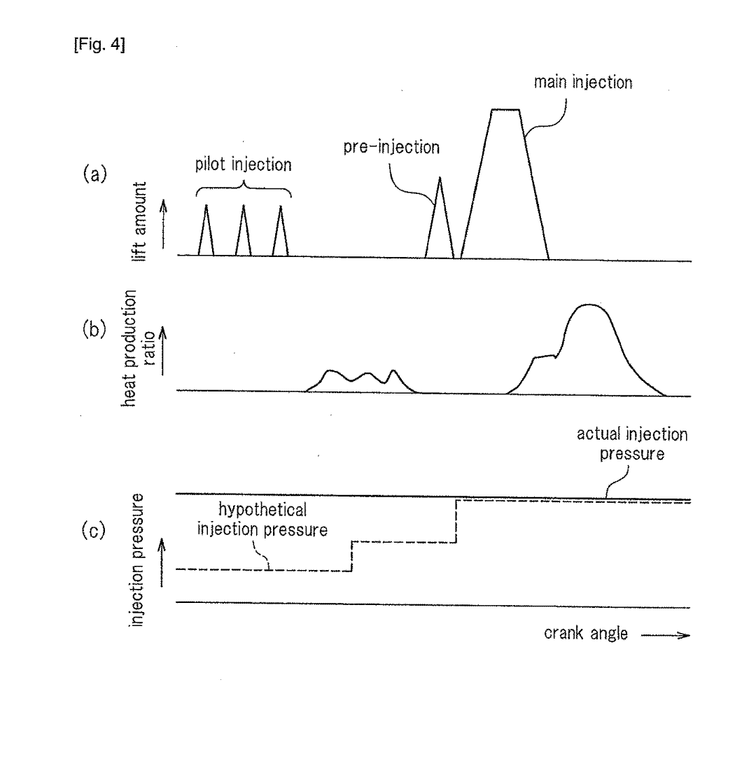

FIGS. 4(a) to 4(c) show the injection patterns for each of pilot injection, pre-injection, and main injection, and the corresponding heat production ratios, in a case where three instances of divided pilot injection are executed (for example, a case where the total pilot injection amount is 4.5 mm³). As shown in FIGS. 4(a) to 4(c), in each instance of divided pilot injection that constitutes the pilot injection, the lift amount of a needle valve provided in the injector 23 is restricted, and thus injection is performed with the above-described minimum injection ratio. Also, immediately after three instances of divided pilot injection are completed, a pressure increase within the cylinder is accompanied by the fuel igniting, and an optimum heat production ratio for performing preheating within the cylinder is obtained.

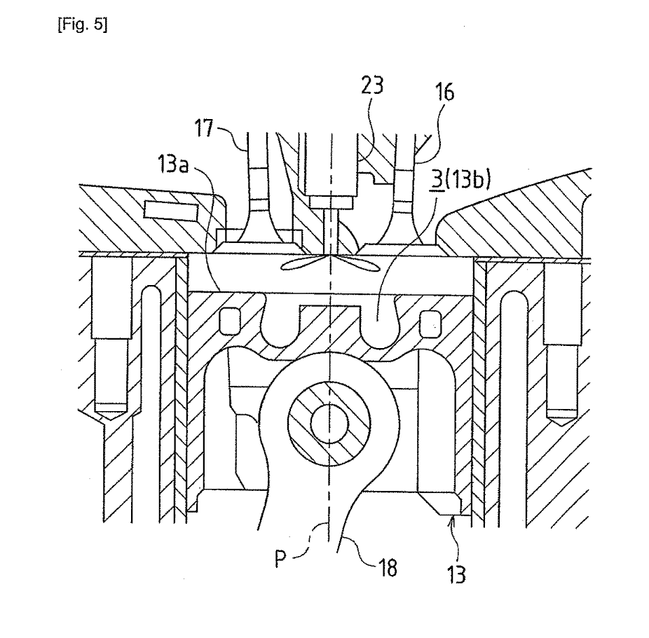

The total pilot injection amount is insured by divided pilot injection being executed a plurality of times with the minimum limit injection amount in this way. Due to executing this sort of divided pilot injection, the fuel injection amount per instance of this divided pilot injection is set such that the fuel penetration is very low, so the flight distance of fuel that has been injected with this divided pilot injection is also suppressed to a short distance, and there is almost no fuel that reaches the cylinder inner wall face. FIG. 5 is a cross-sectional view that shows the combustion chamber 3 of the engine 1 and parts in the vicinity of the combustion chamber 3, when executing divided pilot injection. As shown in FIG. 5, the penetration of fuel injected with divided pilot injection is very low, so the flight distance of that fuel is also suppressed to a short distance, and therefore most of that fuel accumulates in a region facing a cavity 13b formed in approximately the center portion of the piston top face 13a, and at the time when the piston 13 has reached the compression top dead center, most of this fuel flows into the cavity 13b and accumulates within the cavity 13b.

(Total Pilot Injection Amount)

Also, the above total pilot injection amount is calculated based on the compressed gas temperature within the cylinder and the fuel self-ignition temperature. That is, the total pilot injection amount is set larger as the compressed gas temperature within the cylinder becomes further below the fuel self-ignition temperature (operation to calculate the total sub injection amount by a total sub injection amount calculation portion). Following is a description of an example of this total pilot injection amount calculation operation.

In this total pilot injection amount calculation operation, first, the target ignition temperature (Treq) prior to fuel ignition is acquired. This target ignition temperature corresponds to the fuel self-ignition temperature used in the engine 1. This fuel self-ignition temperature changes according to the pressure within the combustion chamber 3. That is, the fuel self-ignition temperature decreases as the pressure within the combustion chamber 3 increases. Therefore, for example, a target ignition temperature map for obtaining the target ignition temperature according to the pressure within the combustion chamber 3 is stored in the aforementioned ROM 102, and the target ignition temperature (Treq) is acquired by referring to this target ignition temperature map.

Also, the target ignition timing (Aign) is acquired. This is acquired as the piston position at the fuel ignition start timing that accompanies main injection when main injection has been performed. For example, this is set as the compression top dead center (crank angle CA=0 degrees) or the like. This target ignition timing (Aign) is not limited to being set to the compression top dead center of the piston 13, and for example may be delayed by an appropriate amount according to exhaust emissions. That is, in the case of operation in which torque of the engine 1 is considered important, the target ignition timing is set near the compression top dead center, and in the case of operation in which suppression of the amount of NOx exhaust is considered important, the target ignition timing is set to after the compression top dead center.

Then, the compressed gas temperature (Treal) at the target ignition timing acquired above is estimated. This compressed gas temperature, when it is assumed that pilot injection is not executed, that is, when it is assumed that there is no increase in gas temperature caused by pilot injection, is a compressed gas temperature that only increases due to compression of gas in the cylinder during the compression stroke. As described above, when the target ignition timing (Aign) is acquired as the compression top dead center of the piston 13, it is acquired as the compressed gas temperature at the point in time when the compression chamber volume is smallest.

Specifically, as this compressed gas temperature estimation operation, the compressed gas temperature (Treal) at the target ignition timing is estimated from the intake air pressure detected by the above intake pressure sensor 48 and the intake air temperature detected by the intake temperature sensor 49. This estimation is performed by calculation according to a predetermined computational formula, or by referring to a map that has been stored in advance in the ROM 102.

After the target ignition temperature (Treq) and the compressed gas temperature (Treal) at the target ignition timing have been acquired as described above, the target ignition temperature and the compressed gas temperature are compared, and a determination is made of whether or not the compressed gas temperature is less than the target ignition temperature (Treq>Treal). When the compressed gas temperature is less than the target ignition temperature, pilot injection is executed prior to main injection. On the other hand, when the compressed gas temperature is at least as much as the target ignition temperature, pilot injection is not executed prior to main injection.

In a case where pilot injection is executed, a required temperature difference (dT) is obtained from below formula (5).

dT=Treq−Treal (5)

Then, the in-cylinder gas amount (Gcyl), the specific heat (Cg) of gas within the cylinder, and the amount of heat produced per unit volume of the fuel (Efuel) are calculated, and the total pilot injection amount (Qp) is calculated from below formula (6).

Qp=Gcyl*dT*Cg/Efuel (6)

### (Pilot Injection Start Timing)

After the total pilot injection amount is determined by the above operation, the injection start timing of pilot injection is set. The injection start timing of pilot injection is set according to below formula (7), for example at a crank angle of 80 degrees or thereafter before compression top dead center (BTDC) of the piston 13.

Pilot injection start angle=pilot combustion end angle+pilot injection period working angle+(crank angle conversion value of combustion required time in one instance of divided pilot injection*number of injection instances of divided pilot injection+crank angle conversion value of ignition delay time−crank angle conversion value of overlap time) (7)

Here, the pilot combustion end angle is an angle set in order to complete combustion by pilot injection before starting pre-injection. The ignition delay time is a delay time from the time when pilot injection is executed to the time when that fuel ignites. The overlap time is an overlap time of the combustion time of fuel from previously executed divided pilot injection and combustion time of fuel from subsequently executed divided pilot injection (time during which two combustions are simultaneously being performed), and an overlap time of the combustion time of fuel from final divided pilot injection and the combustion time of fuel from subsequently executed pre-injection.

(Injection Interval)

Further, in a case where a plurality of instances of divided pilot injection are performed, an injection interval, which is a time interval between instances of divided pilot injection, is obtained as described below.

The injection interval is set such that sprays that have been injected with a plurality of instances of pilot injection do not overlap each other (are not superimposed). This is specifically described below.

In the suction stroke into the engine 1, as for the flow of air that flows into the cylinder, a swirl flow occurs with the above-described cylinder center line P as a center of rotation, and this swirl flow continuously occurs in the cylinder even during the compression stroke.

Therefore, fuel that has been injected with divided pilot injection flows in the circumferential direction in the cylinder due to this swirl flow. That is, with the passage of time in the compression stroke, fuel (a spray cluster) that has been injected with divided pilot injection is caused to flow in the circumferential direction following the swirl flow, from a position facing an injection port of the injector 23 (the position immediately after injection).

Accordingly, at the time of executing subsequent divided pilot injection after divided pilot injection that has been executed previously, the fuel that has been injected with the previously executed divided pilot injection is already flowing in the circumferential direction within the cylinder, so there is no overlapping of fuel from two instances of divided pilot injection that is injected from the same injection port (fuel clusters from both instances of injection are not combined together).

In this case, fuel of divided pilot injection that has been injected from the injection port on the upstream side in the swirl flow direction is flowing towards a position opposing the injection port on the downstream side in the swirl flow direction, so by adjusting the injection timing of subsequent divided pilot injection, it is possible to prevent the fuel that has been injected with each instance of divided pilot injection from combining together, thus allowing each spray to be uniformly dispersed.

More specifically, a case is conceivable in which in an interval from when the piston 13 is at the bottom dead center until the piston 13 reaches the top dead center (an interval in which the piston 13 moves 180 degrees in terms of crank angle), the swirl flow goes around once in the circumferential direction within the cylinder. That is, in this case a swirl ratio is “2”. Also, a case is conceivable in which the number of injection ports of the injector 23 is “10”, and three instances of fuel injection (first divided pilot injection, second divided pilot injection, third divided pilot injection) are performed as divided pilot injection.

In this case, if the interval between each instance of divided pilot injection is set to 12 degrees in the circumferential direction within the cylinder (6 degrees in terms of crank angle), it is possible to prevent the fuel that has been injected with each instance of divided pilot injection from overlapping.

That is, by setting the interval of each instance of divided pilot injection such that below formulas (1) and (2) are satisfied, it is possible to uniformly disperse each spray.

(Number of instances of divided pilot injection)=(total pilot injection amount required in pilot injection)/(injector minimum limit injection amount) (1)

(Crank rotation angle conversion value of interval between instances of divided pilot injection)=360/(number of injection ports of injector)/(number of instances of divided pilot injection)/(swirl ratio) (2)

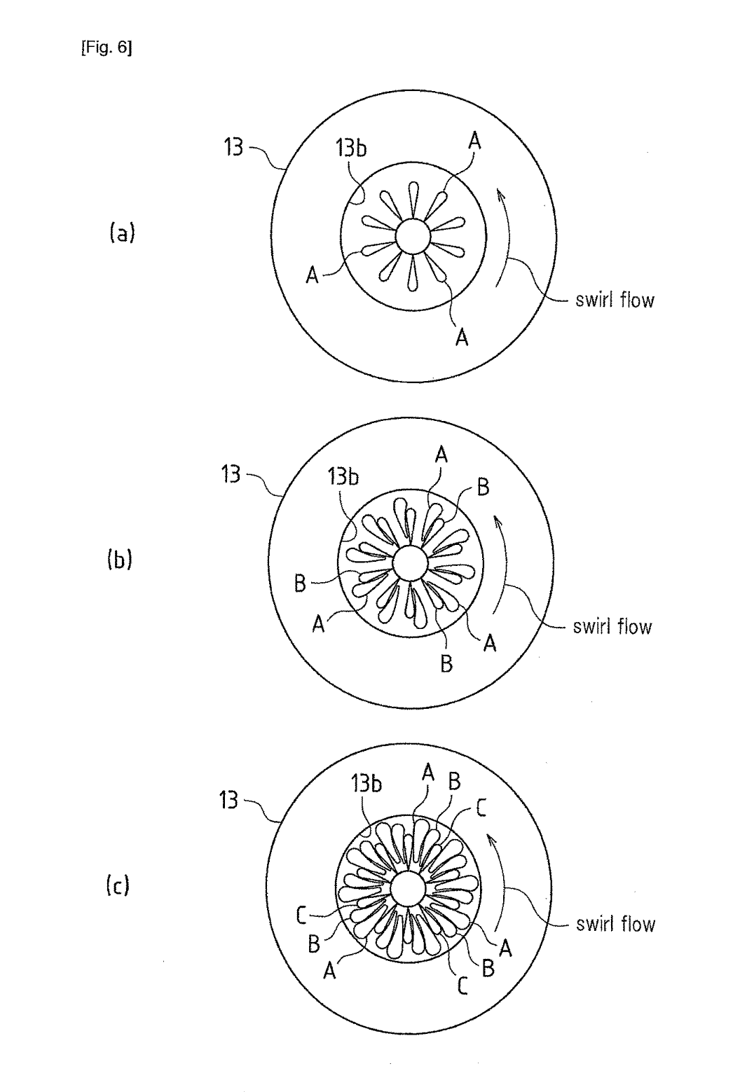

FIGS. 6(a) to 6(c) are plan views that show the spray state in the cylinder in a case where the first, second, and third divided pilot injections are performed. In FIGS. 6(a) to 6(c), reference “A” indicates the spray of fuel that has been injected with the first divided pilot injection, reference “B” indicates the spray of fuel that has been injected with the second divided pilot injection, and reference “C” indicates the spray of fuel that has been injected with the third divided pilot injection.

Also, FIG. 6(a) shows the state of the spray A when executing the first divided pilot injection, FIG. 6(b) shows the state of the sprays A and B when executing the second divided pilot injection, and FIG. 6(c) shows the state of the sprays A, B, and C when executing the third divided pilot injection. As shown in FIGS. 6(b) and 6(c), the spray A of fuel that has been injected with the first divided pilot injection and the spray B of fuel that has been injected with the second divided pilot injection, with the passage of time, flow in the circumferential direction within the cylinder with the swirl flow.

By setting the interval of each instance of divided pilot injection such that above formulas (1) and (2) are satisfied in this manner, it is possible to allow each spray to be uniformly accumulated within the cavity 13b, without the spray of fuel that has been injected with previous divided pilot injection combining together with the spray of fuel that is injected with subsequent divided pilot injection.

Note that the interval between each instance of divided pilot injection may be determined according to the response (speed of opening/closing operation) of the injectors 23. For example, 200 microseconds may be set as the shortest opening/closing period determined according to the performance of the injectors 23. This pilot injection interval is not limited to the above value.

After the injection ratio of divided pilot injection, the total pilot injection amount, the injection start timing of pilot injection, and the injection interval of divided pilot injection have been obtained in the manner described above, fuel injection control of the injectors 23 is performed such that pilot injection is executed according to these values. That is, as described above, by executing pilot injection a plurality of times with the minimum injection ratio (for example, an injection amount per instance of 1.5 mm³)(intermittent fuel injection operation by a sub injection control portion), control of the injectors 23 is performed so as to insure the total pilot injection amount (Qp) necessary in this pilot injection.

As described above, in the present embodiment, the total pilot injection amount required in pilot injection is divided using a plurality of instances of divided pilot injection, and the penetration of fuel injected with an individual instance of divided pilot injection is suppressed to a low level, and thus this fuel is allowed to accumulate locally without being allowed to attach to a wall face.

Thus, even in a case where the fuel pressure (common rail inner pressure) is set to a high pressure in order to achieve atomization of fuel injected with main injection, as for the form of injection of fuel injected with pilot injection, fuel is supplied into the cylinder with a penetration that is as low as in a case where a low fuel pressure has been set. That is, as shown in the timing chart that indicates changes in injection pressure in FIG. 4(c), although a high value is continuously maintained for the actual fuel injection pressure, with respect to the form of injection of fuel injected with pilot injection, the same form of injection is realized as in the case where fuel injection has been performed with the injection pressure indicated by the broken line in FIG. 4(c) (hypothetical injection pressure), and so fuel injection is performed with a low penetration.

Thus, it is possible to suppress wall attachment of fuel injected with pilot injection, and thus, it is possible to prevent dilution of lubricant oil by fuel and occurrence of the above bore flashing. Also, it is possible to greatly reduce the amount of HC and CO produced in exhaust gas that has occurred due to fuel that has attached to the inner wall face of the cylinder, and so an improvement in exhaust emissions is achieved.

Also, because most of the fuel of the total pilot injection amount exists (floats) locally within the cylinder (for example, in the center portion within the cylinder), and in that portion it is possible to insure a rich state of the air-fuel ratio, when the compression stroke has advanced, it is possible to favorably perform ignition of fuel that has been injected with pilot injection, effects due to executing pilot injection (an effect of increasing the in-cylinder temperature) can be favorably obtained, and it possible to appropriately obtain the ignition timing in main injection. For example, when the target ignition timing in main injection has been set to the compression top dead center (TDC) of the piston 13, it is possible to make the ignition timing of fuel that has been injected with main injection match this target ignition timing.

In addition, the injection amount in each instance of divided pilot injection is a small amount in order to obtain a low penetration, so the absorption amount by the endothermic reaction of fuel during the divided pilot injection is slight, an ignition delay does not occur in pilot injection, and thus it is possible to adequately obtain the effects of pilot injection, namely increasing the in-cylinder temperature. Also, there is no increase in combustion noise caused by an ignition delay in pilot injection, and no production of torque (reverse torque) before the piston 13 reaches the compression top dead center.

For the above reasons, the total pilot injection amount, which was limited in the conventional technology, is not limited according to the present embodiment, and so a total pilot injection amount with an amount corresponding to the operational state of the engine 1 can be supplied into the cylinder. For example, in a case where a large total pilot injection amount is required (a case where a large amount of temperature increase of the in-cylinder temperature is required), such as when the engine 1 is cold, it is possible to insure a comparatively large total pilot injection amount, without allowing wall attachment of fuel, and it is possible to adequately pre-heat the inside of the cylinder by effectively using most of fuel that has been injected with pilot injection. Therefore, in the present embodiment, it is possible to achieve both lower penetration of fuel injected with pilot injection and an increased total pilot injection amount.

### Other Embodiments

In the embodiment described above, a case was described in which the invention is applied to an in-line four cylinder diesel engine mounted in an automobile. The invention is not limited to use in an automobile, and is also applicable to engines used in other applications. Also, the number of cylinders and the form of the engine (in-line engine, V-type engine, or the like) is not particularly limited.

Further, in the above embodiment, the maniverter 77 is provided with the NSR catalyst 75 and the DPNR catalyst 76, but a maniverter 77 provided with the NSR catalyst 75 and a DPF (Diesel Particulate Filter) may also be adopted.

Also, in the above embodiment, when calculating the total pilot injection amount, the compressed gas temperature (Treal) at the target ignition timing is estimated, but a configuration may also be adopted in which a cylinder inner pressure sensor is provided within the cylinder, and the compressed gas temperature (Treal) at the target ignition timing is obtained from the cylinder inner pressure that has been detected with this cylinder inner pressure sensor and the intake air temperature that has been detected with the above-described intake temperature sensor 49.

Further, the number of instances of divided pilot injection may be determined from the following formula (8).

N={(Ca*dTs)*Kc*Kv}/(J*Y) (8)

(N: injection instances of divided pilot injection, Ca: heat capacity of air introduced into cylinder, dTs: temperature of portion that has not reached self-ignition temperature, Kc: heat capacity correction coefficient from EGR ratio, Kv: space subject to combustion contribution, J: theoretical amount of heat produced in 1.5 mm³, Y: heat efficiency)
Here, the temperature dTs of the portion that has not reached self-ignition temperature is the difference between the fuel self-ignition temperature and the compressed gas temperature at the target ignition timing (for example, the timing at which the piston 13 has reached the compression top dead center) of fuel during main injection, and corresponds to the amount of heat necessary to allow the compressed gas temperature at the target ignition timing to reach the fuel self-ignition temperature. Note that in above formula (8), the divided pilot injection amount per one instance is set to a fixed value (for example, 1.5 mm³), and by setting the number of instances of injection, the necessary total pilot injection amount is insured. This fixed value of the divided pilot injection amount is not limited to the value stated above.

Also, in the above embodiment, a low penetration that does not allow wall attachment of fuel is realized by setting the form of injection per one instance of divided pilot injection to the minimum limit injection amount (1.5 mm³) of the injectors 23. The present invention is not limited to this; a configuration may also be adopted in which a low penetration that does not allow wall attachment of fuel is realized by setting the form of injection per one instance of divided pilot injection to the shortest open valve period (for example, 200 microseconds) of the injectors 23.

Also, because the minimum limit injection amount of the injectors 23 described above fluctuates due to the influence of the fuel pressure, a configuration may also be adopted in which a low penetration that does not allow wall attachment of fuel is realized by selecting, according to the operational state of the engine 1, one of regulation of the form of injection by the minimum limit injection amount and regulation of the form of injection by the shortest open valve period. For example, when the form of injection per one instance of divided pilot injection has been set to the shortest open valve period of the injectors 23, in a condition in which the fuel pressure (common rail inner pressure) is comparatively low, there is a possibility that the minimum limit injection amount (1.5 mm³) cannot be insured as the above divided pilot injection amount, so that the effects of preheating the inside of the cylinder will not be adequately exhibited, and therefore, in this condition, the form of injection per one instance of divided pilot injection is switched to regulation by the minimum limit injection amount of the injectors 23, so that the effects of preheating the inside of the cylinder can be obtained. Conversely, when the form of injection per one instance of divided pilot injection has been set to the minimum limit injection amount of the injectors 23, in a condition in which the fuel pressure (common rail inner pressure) is comparatively high, there is a possibility that the open valve period of the injectors 23 for obtaining the above minimum limit injection amount cannot be realized, so in such a condition, the form of injection per one instance of divided pilot injection is switched to regulation by the shortest open valve period of the injectors 23.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

This application claims priority on Japanese Patent Application No. 2008-004198 filed in Japan on Jan. 11, 2008, the entire contents of which are herein incorporated by reference. Furthermore, the entire contents of references cited in the present description are herein specifically incorporated by reference.

1. A fuel injection control apparatus of a compression self-igniting internal combustion engine that, as an operation to inject fuel from a fuel injection valve, is capable of executing at least a main injection and a sub-injection that is performed prior to the main injection, the fuel injection control apparatus comprising:
a total sub-injection amount calculation portion that obtains a total sub-injection amount required in the sub-injection; and
a sub-injection control portion that intermittently injects from the fuel injection valve the total sub-injection amount that has been obtained with the total sub-injection amount calculation portion by dividing the total sub-injection amount by a plurality of instances of divided sub-injection; wherein
a fuel injection amount or an open valve period of the fuel injection valve per one instance of the divided sub-injection is set as a value whereby penetration of fuel injected from the fuel injection valve is limited to a size such that fuel does not reach a cylinder inner wall face; and
the sub-injection control portion is configured to set the injection timing of each instance of divided sub-injection such that fuel is injected at a timing that the fuel does not overlap with fuel that is injected with each instance of divided sub-injection and flows along a swirl flow within the cylinder.

2. The fuel injection control apparatus of an internal combustion engine according to claim 1, wherein
the fuel injection valve injects fuel from a plurality of injection ports; and the sub-injection control portion, in a state that fuel of divided sub-injection that has been injected from the injection port on the upstream side in the swirl flow direction is flowing towards a position opposing the injection port on the downstream side in the swirl flow direction, is configured to set the injection timing of each instance of divided sub-injection such that a subsequent instance of divided sub-injection is executed before the fuel of the previously-executed instance of divided sub-injection arrives at the position opposing the injection port on the downstream side in the swirl flow direction.

3. The fuel injection control apparatus of an internal combustion engine according to claim 1, wherein the sub-injection control portion is configured, for a number of injection instances of divided sub-injection calculated with the below formula (1),
(number of instances of divided sub-injection)=(total sub-injection amount required in sub-injection)/(minimum limit injection amount of fuel injection valve) (1)
to execute the divided sub-injection at each of a crank rotation angle conversion value of an interval between instances of divided sub-injection calculated with the below formula (2)
(crank rotation angle conversion value of interval between instances of divided sub-injection)=360/(number of injection ports of fuel injection valve)/(number of instances of divided sub-injection)/(swirl ratio) (2).

4. The fuel injection control apparatus of an internal combustion engine according to claim 1, wherein the sub-injection control portion is configured to set the fuel injection amount per one instance of the divided sub-injection to a minimum limit injection amount of the fuel injection valve.

5. The fuel injection control apparatus of an internal combustion engine according to claim 1, wherein the sub-injection control portion is configured to set the open valve period of the fuel injection valve per one instance of the divided sub-injection to a shortest open valve period of the fuel injection valve.

6. The fuel injection control apparatus of an internal combustion engine according to claim 1, wherein:
the fuel injected with the sub-injection, due to combustion of that fuel, is used as a heat source for raising the compressed gas temperature within the cylinder to the fuel self-ignition temperature during a compression stroke of the internal combustion engine; and
the total sub-injection amount calculation portion sets a greater total sub-injection amount as the compressed gas temperature within the cylinder becomes further below the fuel self-ignition temperature.
